(19) United States
(12) Patent Application Publication
(10) Pub. No.: US 2024/0381282 A1
(43) Pub. Date: Nov. 14, 2024

(54) METHOD AND USER EQUIPMENT TO DEACTIVATE UNAVAILABILITY PERIOD IN DEREGISTERED STATE IN WIRELESS COMMUNICATION NETWORK

(71) Applicant: MediaTek Singapore Pte. Ltd., Singapore (SG)

(72) Inventors: Puneet, Bengaluru KA (IN); Marko Niemi, Oulu (FI)

(21) Appl. No.: 18/646,855

(22) Filed: Apr. 26, 2024

(30) Foreign Application Priority Data
May 9, 2023 (IN) 202321032829

(51) Int. Cl. H04W 60/02; H04W 60/04

(52) U.S. Cl. CPC H04W 60/02; H04W 60/04

(57) ABSTRACT

A method and a user equipment to deactivate an unavailability period in a deregistered state in a wireless communication network are provided. A method to deactivate an unavailability period in a deregistered state in a wireless communication network is provided. The method includes: detecting whether a user equipment (UE) performs an initial registration to come out of the unavailability period and resume normal services; and controlling the user equipment (UE) in the deregistered state to initiate a registration procedure for initial registration, when the user equipment (UE) performs initial registration to come out of the unavailability period and resume the normal services.

This application claims the benefit of India Provisional application Serial No. 202321032829, filed May 9, 2023, the disclosure of which is incorporated by reference herein in its entirety.

### TECHNICAL FIELD

The disclosure relates in general to a method and an electronic device, and more particularly to a method and a user equipment to deactivate an unavailability period in a deregistered state in a wireless communication network.

### BACKGROUND

The “unavailability period” for the user equipment (UE) is used to executes required events like Silent modem reset, security patch updates, OS upgrades, MODEM SW upgrades and device reboot MODEM setting changes via OMA-DM, satellite discontinuous coverage.

If the user equipment (UE) and network support unavailability period and an event is triggered in the user equipment (UE) or satellite discontinuous coverage making the user equipment (UE) unavailable for a certain period of time, the user equipment (UE) shall activate the unavailability period and may store its 5GMM and 5GSM context in USIM or non-volatile memory to be able to reuse it after the unavailability period.

To activate the unavailability period, the user equipment (UE) provides an unavailability period duration during the registration procedure or during the de-registration procedure (see 3GPP TS 23.501 and 3GPP TS 23.502). The support for the unavailability period is negotiated in the registration procedure.

There are some problems to be solved:

In registered state, mobility registration update procedure is defined to come out of unavailability period and resume normal service.

The user equipment (UE) can activate unavailability period using de-registration procedure. After de-registration procedure is completed, the user equipment (UE) will stay in unavailability mode and the user equipment (UE) 5GMM state will be changed from registered to de-registered states.

In deregistered state, there is undefined for the user equipment (UE) to come out of unavailability period and resume normal service.

In addition to that, when deregistration procedure is performed due to unavailability period, N1 mode capability is disabled. Once unavailability period is deactivated, then the user equipment (UE) can't initiate registration procedure without enabling N1 mode capability.

### SUMMARY

The disclosure is directed to a method and a user equipment to deactivate an unavailability period in a deregistered state in a wireless communication network.

According to one embodiment, a method to deactivate an unavailability period in a deregistered state in a wireless communication network is provided. The method includes: detecting whether a user equipment (UE) performs an initial registration to come out of the unavailability period and resume normal services; and controlling the user equipment (UE) in the deregistered state to initiate a registration procedure for initial registration, when the user equipment (UE) performs initial registration to come out of the unavailability period and resume the normal services.

According to another embodiment, a method to deactivate an unavailability period in a deregistered state in a wireless communication network is provided. The method includes: detecting whether the user equipment (UE) enables an N1 mode capability for 3GPP access again to come out of unavailability period and resume normal services; and controlling the user equipment (UE) to enable the N1 mode capability for 3GPP access when the N1 mode capability for 3GPP access was disabled due to the user equipment (UE) initiated de-registration procedure for 3GPP access or for 3GPP access and non-3GPP access, the user equipment (UE) is operating in single-registration mode and the user equipment (UE) comes out of the unavailability period and resume normal services.

According to an alternative embodiment, a user equipment (UE) is provided. The user equipment (UE) includes a transceiver and a processor. The transceiver is configured to wirelessly communicate with a network. The processor is coupled to the transceiver and configured to perform operations comprising: detecting whether the user equipment (UE) enables an N1 mode capability for 3GPP access again to come out of unavailability period and resume normal services; and controlling the user equipment (UE) to enable the N1 mode capability for 3GPP access when the N1 mode capability for 3GPP access was disabled due to the user equipment (UE) initiated de-registration procedure for 3GPP access or for 3GPP access and non-3GPP access, the user equipment (UE) is operating in single-registration mode and the user equipment (UE) comes out of the unavailability period and resume normal services.

### BRIEF DESCRIPTION OF THE DRAWINGS

FIG. 1 illustrates an example network environment in which various solutions and schemes in accordance with the present disclosure may be implemented.

FIG. 2 illustrates a method to deactivate an unavailability period in a deregistered state in a wireless communication network according to one embodiment of the present disclosure.

FIG. 3 illustrates a method to deactivate an unavailability period in a deregistered state in a wireless communication network according to another embodiment of the present disclosure.

FIG. 4 illustrates the user equipment (UE) in accordance with an implementation of the present disclosure.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

The technical terms used in this specification refer to the idioms in this technical field. If there are explanations or definitions for some terms in this specification, the explanation or definition of this part of the terms shall prevail. Each embodiment of the present disclosure has one or more technical features. To the extent possible, a person with ordinary skill in the art may selectively implement some or all of the technical features in any embodiment, or selectively combine some or all of the technical features in these embodiments.

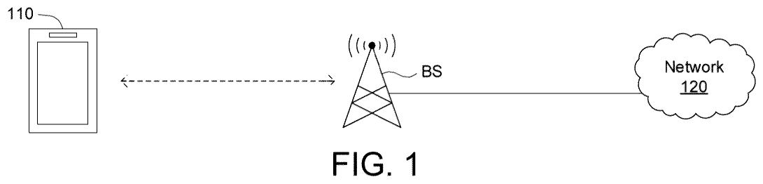

Please refer to FIG. 1, which illustrates an example network environment 100 in which various solutions and schemes in accordance with the present disclosure may be implemented. Referring to the FIG. 1, the network environment 100 may involve a user equipment (UE) 110 in wireless communication with a wireless network 120 (e.g., a 5G NR mobile network) as part of a communication network. The user equipment (UE) 110 may initially be in wireless communication with wireless network 120 via a base station BS or network node (e.g., an eNB, gNB or transmit-receive point (TRP)). In the network environment 100, the user equipment (UE) 110, the base station BS and the network 120 may implement various schemes pertaining to the user equipment (UE) behavior to activate an unavailability period during an active Non-Access Stratum (NAS) congestion in a wireless communication network, as described herein.

During Registration procedure, the user equipment (UE) 110 supporting the Unavailability Period feature provides “Unavailability Period Support” indication as part of 5GMM Core Network Capability in Registration Request message for initial registration and for every mobility registration update procedure. The Access and Mobility Management Function (AMF) indicates whether the corresponding feature is supported in the AMF by providing the “Unavailability Period Support” indication in Registration Accept message.

If the user equipment (UE) 110 and the network 120 support Unavailability Period and an event is triggered in the user equipment (UE) 110 that would make the user equipment (UE) 110 unavailable or lose coverage for a certain period of time, the user equipment (UE) 110 uses Support of Unavailability Period to inform the AMF of the expected unavailability and whether it is due to NR satellite access discontinuous coverage. Use of Support of Unavailability Period for loss of coverage due to NR satellite access discontinuous coverage shall only be used if both the user equipment (UE) 110 and the AMF signaled “Unavailable Period support”.

If the use of Support of Unavailability Period is not due to NR satellite access discontinuous coverage, the user equipment (UE) 110 may store its MM and SM context in the USIM or Non-Volatile memory in the ME to be able to reuse it after its unavailability period. If the user equipment (UE) 110 can store its 5GMM and 5GSM contexts the user equipment (UE) 110 may trigger Mobility Registration Update procedure otherwise the user equipment (UE) 110 shall trigger UE-initiated Deregistration procedure.

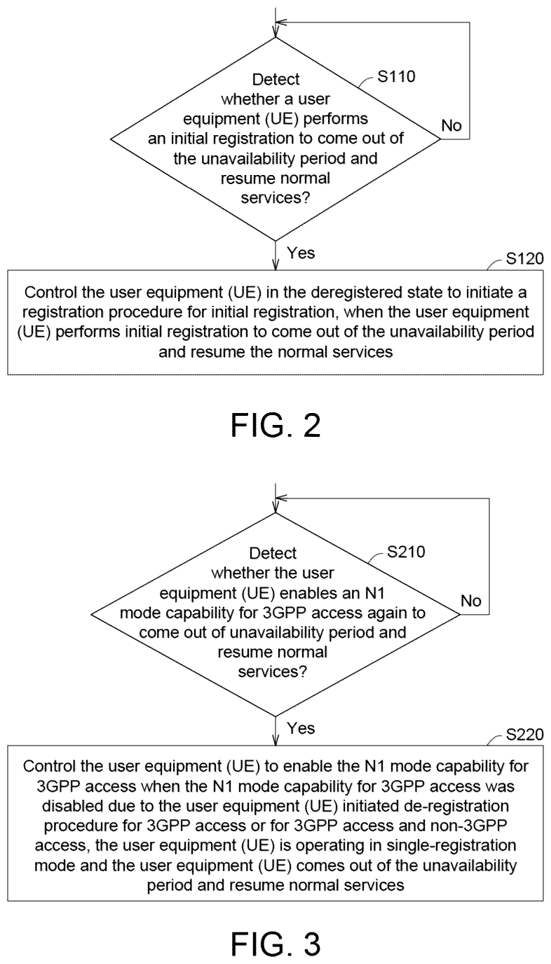

Please referring to FIG. 2, which illustrates a method to deactivate an unavailability period in a deregistered state in a wireless communication network according to one embodiment of the present disclosure. In deregistered state, there is no procedure defined for the user equipment (UE) to come out of unavailability period and resume normal service. To deactivate the unavailability period in the deregistered state in the wireless communication network, the user equipment (UE) 110 is configured to perform the following steps S110 and S120.

In the step S110, whether the user equipment (UE) performs an initial registration to come out of the unavailability period and resume normal services is detected.

In the step S120, the user equipment (UE) is controlled in the deregistered state (i.e. the 5GMM-DEREGISTERED state) to initiate the registration procedure for initial registration by sending a REGISTRATION REQUEST message to an AMF, when the user equipment (UE) performs initial registration to come out of the unavailability period and resume the normal services.

In summary, if the user equipment (UE) deregistered for unavailability period, then to come out of unavailability period (to resume normal services), the user equipment (UE) shall initiate the registration procedure for initial registration.

In detail, “Initial registration initiation” could include:

The user equipment (UE) in state 5GMM-DEREGISTERED shall initiate the registration procedure for initial registration by sending a REGISTRATION REQUEST message to the AMF,
(a) when the UE performs initial registration for 5GS services;
(b) when the UE performs initial registration for emergency services;
(c) when the UE performs initial registration for SMS over NAS;
(d) when the UE moves from GERAN to NG-RAN coverage or the UE moves from a UTRAN to NG-RAN coverage and the following applies:
   (1) the UE initiated a GPRS attach or routing area updating procedure while in A/Gb mode or Iu mode; or
   (2) the UE has performed 5G-SRVCC from NG-RAN to UTRAN as specified in 3GPP TS 23.216,
and since then the UE did not perform a successful EPS attach or tracking area updating procedure in S1 mode or registration procedure in N1 mode;
(e) when the UE performs initial registration for onboarding services in SNPN;
(f) when the UE performs initial registration for disaster roaming services; and
(x) when the UE performs initial registration to come out of unavailability period and resume normal services.

Please referring to FIG. 3, which illustrates a method to deactivate an unavailability period in a deregistered state in a wireless communication network according to another embodiment of the present disclosure. When deregistration procedure is performed due to unavailability period, N1 mode capability is disabled. Once unavailability period is deactivated, then the user equipment (UE) can't initiate registration procedure without enabling N1 mode capability. To deactivate the unavailability period in the deregistered state in the wireless communication network, the user equipment (UE) 110 is configured to perform the following steps S210 and S220.

In the step S210, whether the user equipment (UE) enables an N1 mode capability for 3GPP access again to come out of unavailability period and resume normal services.

In the step S220, the user equipment (UE) is controlled the user equipment (UE) to enable the N1 mode capability for 3GPP access when the N1 mode capability for 3GPP access was disabled due to the user equipment (UE) initiated de-registration procedure for 3GPP access or for 3GPP access and non-3GPP access, the user equipment (UE) is operating in single-registration mode and the user equipment (UE) comes out of the unavailability period and resume normal services.

In summary, if the user equipment (UE) disabled N1 mode capability due to deregistration, then when user equipment (UE) deactivates the unavailability period, then
the user equipment (UE) shall enable N1 mode capability; and
initiate the registration procedure for initial registration.

Alternatively, the user equipment (UE) shall not disable N1 mode capability when deregistration procedure is initiated due to activation of the unavailability period.

In detail, “Disabling and re-enabling of UE's N1 mode capability for 3GPP access” could include:

In detail, “Initial registration initiation” could include:

If the N1 mode capability for 3GPP access was disabled due to the user equipment (UE) initiated de-registration procedure for 3GPP access or for 3GPP access and non-3GPP access and the user equipment (UE) is operating in single-registration mode (see subclause 5.5.2.2.3), upon request of the upper layers to re-register for 5GS services over 3GPP access or the user equipment (UE) needs to come out of unavailability period and resume normal services, the user equipment (UE) shall enable the N1 mode capability for 3GPP access again.

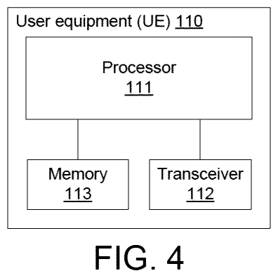

Please refer to FIG. 4, which illustrates the user equipment (UE) 110 in accordance with an implementation of the present disclosure. The user equipment 110 may perform various functions to implement schemes, techniques, processes and methods described herein pertaining to UE behavior in mobile communications, including the various schemes described above with respect to various proposed designs, concepts, schemes, systems and methods described above, including the network environment 100, as well as processes described below.

The user equipment (UE) 110 may be a part of an electronic apparatus, which may be a network apparatus, such as a portable or mobile apparatus, a wearable apparatus, a vehicular device or a vehicle, a wireless communication apparatus or a computing apparatus. For instance, the user equipment (UE) 110 may be implemented in a smartphone, a smart watch, a personal digital assistant, an electronic control unit (ECU) in a vehicle, a digital camera, or a computing equipment such as a tablet computer, a laptop computer or a notebook computer. The user equipment may also be a part of a machine type apparatus, which may be an IoT apparatus such as an immobile or a stationary apparatus, a home apparatus, a roadside unit (RSU), a wire communication apparatus or a computing apparatus. For instance, the user equipment (UE) may be implemented in a smart thermostat, a smart fridge, a smart door lock, a wireless speaker or a home control center. When implemented in or as a network apparatus, the user equipment (UE) 110 may be implemented in an eNodeB in an LTE, LTE-Advanced or LTE-Advanced Pro network or in a gNB or TRP in a 5G network, an NR network or an IoT network.

In some implementations, the user equipment (UE) 110 may be implemented in the form of one or more integrated-circuit (IC) chips such as, for example and without limitation, one or more single-core processors, one or more multi-core processors, one or more complex-instruction-set-computing (CISC) processors, or one or more reduced-instruction-set-computing (RISC) processors. In the various schemes described above, the user equipment (UE) 110 may be implemented in or as a network apparatus. The user equipment (UE) 110 may include at least some of those components shown in the FIG. 3, such as a processor 111, a transceiver 112 and a memory 113, for example. The user equipment (UE) 110 may further include one or more other components not pertinent to the proposed scheme of the present disclosure (e.g., internal power supply, display device and/or user interface device).

In one aspect, the processor 111 may be implemented in the form of one or more single-core processors, one or more multi-core processors, or one or more CISC or RISC processors. That is, even though a singular term “a processor” is used herein to refer to the processor 111, the processor 111 may include multiple processors in some implementations and a single processor in other implementations in accordance with the present disclosure. In another aspect, the processor 111 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, the processor is a special-purpose machine specifically designed, arranged and configured to perform specific tasks including those pertaining to the user equipment (UE) 110 behavior for failed registration and service requests for emergency services fallback in mobile communications in accordance with various implementations of the present disclosure.

The transceiver 112 is coupled to the processor 111. The transceiver 112 may be capable of wirelessly transmitting and receiving data. In some implementations, the transceiver 112 may be capable of wirelessly communicating with different types of wireless networks of different radio access technologies (RATs). In some implementations, the transceiver 112 may be equipped with a plurality of antenna ports (not shown) such as, for example, four antenna ports. That is, the transceiver 112 may be equipped with multiple transmit antennas and multiple receive antennas for multiple-input multiple-output (MIMO) wireless communications.

The memory 113 is coupled to the processor 111 and stores data therein. The memory 113 may include a type of random-access memory (RAM) such as dynamic RAM (DRAM), static RAM (SRAM), thyristor RAM (T-RAM) and/or zero-capacitor RAM (Z-RAM). Alternatively, or additionally, the memory 113 may include a type of read-only memory (ROM) such as mask ROM, programmable ROM (PROM), erasable programmable ROM (EPROM) and/or electrically erasable programmable ROM (EEPROM). Alternatively, or additionally, the memory 113 may include a type of non-volatile random-access memory (NVRAM) such as flash memory, solid-state memory, ferroelectric RAM (FeRAM), magnetoresistive RAM (MRAM) and/or phase-change memory.

The processor 111 of the user equipment (UE) 110, is configured to perform operations described as above.

The above disclosure provides various features for implementing some implementations or examples of the present disclosure. Specific examples of components and configurations (such as numerical values or names mentioned) are described above to simplify/illustrate some implementations of the present disclosure. Additionally, some embodiments of the present disclosure may repeat reference symbols and/or letters in various instances. This repetition is for simplicity and clarity and does not inherently indicate a relationship between the various embodiments and/or configurations discussed.

It will be apparent to those skilled in the art that various modifications and variations can be made to the disclosed embodiments. It is intended that the specification and examples be considered as exemplars only, with a true scope of the disclosure being indicated by the following claims and their equivalents.

What is claimed is:

1. A method to deactivate an unavailability period in a deregistered state in a wireless communication network, comprising:
detecting whether a user equipment (UE) performs an initial registration to come out of the unavailability period and resume normal services; and
controlling the user equipment (UE) in the deregistered state to initiate a registration procedure for initial registration, when the user equipment (UE) performs initial registration to come out of the unavailability period and resume the normal services.

2. The method according to claim 1, wherein the user equipment is in a 5GMM-DEREGISTERED state.

3. The method according to claim 1, wherein the user equipment (UE) in the deregistered state initiates the registration procedure for initial registration by sending a REGISTRATION REQUEST message to an AMF.

4. A method to deactivate an unavailability period in a deregistered state in a wireless communication network, comprising:
detecting whether the user equipment (UE) enables an N1 mode capability for 3GPP access again to come out of unavailability period and resume normal services; and
controlling the user equipment (UE) to enable the N1 mode capability for 3GPP access when the N1 mode capability for 3GPP access was disabled due to the user equipment (UE) initiated de-registration procedure for 3GPP access or for 3GPP access and non-3GPP access, the user equipment (UE) is operating in single-registration mode and the user equipment (UE) comes out of the unavailability period and resume normal services.

5. The method according to claim 4, further comprising:
controlling the user equipment (UE) comes out of the unavailability period, if the N1 mode capability for the 3GPP access is disabled due to the user equipment (UE) initiated the de-registration procedure.

6. The method according to claim 4, further comprising:
controlling the user equipment (UE) to enable the N1 mode capability, when the user equipment (UE) deactivates the unavailability period.

7. The method according to claim 4, further comprising:
controlling the user equipment (UE) to initiate the registration procedure for initial registration, when the user equipment (UE) deactivates the unavailability period.

8. The method according to claim 4, further comprising:
controlling the user equipment (UE) not to disable the N1 mode capability, when the de-registration procedure is initiated due to activate of the unavailability period.

9. A user equipment (UE), comprising:
a transceiver, configured to wirelessly communicate with a network;
a processor, coupled to the transceiver and configured to perform operations comprising:
detecting whether the user equipment (UE) enables an N1 mode capability for 3GPP access again to come out of unavailability period and resume normal services; and
controlling the user equipment (UE) to enable the N1 mode capability for 3GPP access when the N1 mode capability for 3GPP access was disabled due to the user equipment (UE) initiated de-registration procedure for 3GPP access or for 3GPP access and non-3GPP access, the user equipment (UE) is operating in single-registration mode and the user equipment (UE) comes out of the unavailability period and resume normal services.

10. The user equipment (UE) according to claim 9, wherein the user equipment (UE) is further configured to perform:
controlling the user equipment (UE) to comes out of the unavailability period, if the N1 mode capability for the 3GPP access is disabled due to the user equipment (UE) initiated the de-registration procedure.

11. The user equipment (UE) according to claim 9, wherein the user equipment (UE) is further configured to perform:
controlling the user equipment (UE) to enable the N1 mode capability, when the user equipment (UE) deactivates the unavailability period.

12. The user equipment (UE) according to claim 9, wherein the user equipment (UE) is further configured to perform:
controlling the user equipment (UE) to initiate the registration procedure for initial registration, when the user equipment (UE) deactivates the unavailability period.

13. The user equipment (UE) according to claim 9, wherein the user equipment (UE) is further configured to perform:
controlling the user equipment (UE) not to disable the N1 mode capability, when the de-registration procedure is initiated due to activate of the unavailability period.
